(19) United States
(12) Patent Application Publication
(10) Pub. No.: US 2008/0159505 A1
(43) Pub. Date: Jul. 3, 2008

(54) SYSTEM AND METHOD FOR PROVIDING CONFIGURATION INFORMATION TO A FIXED COMMUNICATION DEVICE

(75) Inventors: Satish Kumar M. Mundra, Germantown, MD (US); Manoj Sindhwani, Oakhill, VA (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/962,498

(22) Filed: Dec. 21, 2007

Related U.S. Application Data
(60) Provisional application No. 60/877,264, filed on Dec. 27, 2006.

(51) Int. Cl. H04M 3/42

(52) U.S. Cl. 379/201.01

(57) ABSTRACT

A gateway includes a transceiver operable to transmit and receive communications to a fixed communication device; and a processor cooperatively operable with the transceiver. The processor is configured to facilitate establishing an FXS/FXO connection to the fixed communication device; detecting a configuration query received via the transceiver from the fixed communication device, the configuration query indicating a network infrastructure device for which configuration information is requested; obtaining configuration information corresponding to the network infrastructure device; providing a message with the configuration information inserted therein; and transmitting the message to the fixed communication device via the transceiver.

### CROSS-REFERENCE TO RELATED APPLICATIONS

This application claims the benefit of the U.S. Provisional Application No. 60/877,264 filed Dec. 27, 2006, which is expressly incorporated herein by reference.

### TECHNICAL FIELD

The technical field relates in general to communications between a residential gateway and a fixed communication device connected to the gateway for access to Internet telephony, and more specifically, to the provisioning of a protocol to provide enhanced functionality to fixed communication devices.

### BACKGROUND

Residential gateways (sometimes referred to as service gateways, home gateways, and access devices) are a key part of the home networking solution. They provide a platform for integrating different broadband access technologies and several home networking solutions. A residential gateway can connect a local area network (LAN) in a home to the Internet. A hardware device similar to a router, the residential gateway provides a unique combination of features.

By definition, a gateway joins two networks together. Gateway hardware exists in multiple forms including general-purpose servers with multiple network adapters and routers. Traditional gateways have been installed in server rooms or closets, but residential gateways bring these devices into the home. Home gateways vary significantly in their capabilities, so that no one “typical” home gateway exists. However, most residential gateways support some basic features, broadband (often DSL (digital subscriber line)) service connectivity, Internet connection sharing and firewall security. This connectivity can bring VoIP (voice over Internet protocol) into the local network, allowing the connection of a telephone system to VoIP through the gateway.

By connecting the home or small office network to the Internet, a residential gateway provides translation and allows access to a DSL or cable modem Internet connection. The residential gateway sits between the DSL or cable modem which downloads and uploads data, voice, and video, and provides Internet access and an internal network. Alternately, a DSL or cable modem might be integrated into the residential gateway. However, a conventional residential gateway connected to a conventional home telephone typically acts as a barrier to providing information to the conventional home telephone.

For a gateway, such as a voice over IP gateway, there is no trivial way for a user to find the IP address of a network infrastructure device (or other device configuration information) which may be desired for troubleshooting or for communicating with the network infrastructure device. For local devices that provide telephony services, conventional solutions include announcing device configurations to the user when the fixed communication device goes off-hook, or printing a device configuration page at devices that have a print capability. However, the use of voice announcements can take significant flash space. Moreover, most fixed communication devices do not include a print capability.

### SUMMARY

Accordingly, one or more embodiments provide a gateway having a transceiver operable to transmit and receive communications to a fixed communication device; and a processor cooperatively operable with the transceiver. The processor is configured to facilitate establishing an FXS/FXO connection to the fixed communication device; detecting a configuration query received via the transceiver from the fixed communication device, the configuration query indicating a network infrastructure device for which configuration information is requested; obtaining configuration information corresponding to the network infrastructure device; providing a message with the configuration information inserted therein; and transmitting the message to the fixed communication device via the transceiver.

Other embodiments further provide for computer-readable medium comprising instructions being executed by a computer, the instructions including a computer-implemented method for providing configuration information from a gateway to a fixed communication device. The instructions provide for establishing an FXS/FXO connection from a gateway to a fixed communication device; detecting a configuration query received from the fixed communication device over the FXS/FXO connection, the configuration query indicating a network infrastructure device for which configuration information is requested; obtaining configuration information corresponding to the network infrastructure device; providing a message with the configuration information inserted therein; and transmitting the message to the fixed communication device over the FXS/FXO connection.

Still other embodiments provide for a computer-implemented method for providing configuration information from a gateway to a fixed communication device. The method includes establishing an FXS/FXO connection from a gateway to a fixed communication device; detecting a configuration query received at the gateway from the fixed communication device over the FXS/FXO connection, the configuration query indicating a network infrastructure device for which configuration information is requested; obtaining, at the gateway, configuration information corresponding to the network infrastructure device; providing a message with the configuration information inserted therein; and transmitting the message with the configuration information from the gateway to the fixed communication device over the FXS/FXO connection.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to fiber illustrate various exemplary embodiments and to explain various principles and advantages in accordance with the embodiments.

FIG. 1 is a diagram illustrating a simplified and representative environment associated with a fixed communication device and a gateway;

FIG. 2 is a diagram illustrating portions of a gateway;

FIG. 3 is a block diagram illustrating portions of a MDMF (multiple data message format) message;

FIG. 4 is a packet flow diagram illustrating a flow of transmissions for providing configuration information from a gateway to a fixed communication device; and

FIG. 5 is a flow chart illustrating an exemplary procedure for providing configuration information.

### DETAILED DESCRIPTION

In overview, the present disclosure concerns gateways and fixed communication devices which are configured to connect together, and wherein gateways are further connected between fixed communication devices and communication networks, often referred to as voice over packet (VOP) networks, such as may be associated with networks supporting voice communication. Such communication networks may provide additional services such as data communications, signal, and/or video services. Such communication networks can include network infrastructure devices which transfer the communications between endpoints, for example by forwarding the communications which may have been broken into communication packets and may be reassembled. More particularly, various inventive concepts and principles are embodied in systems, devices, and methods therein for providing communications between a gateway and a fixed communication device, optionally in a VOP network environment, to provide a visual display at the fixed communication device of configuration information for a network infrastructure device.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed so that a fixed communication device can dial predefined feature codes and configuration information for a network infrastructure device will be provided by the gateway and displayed on a caller ID (CID) display at the fixed communication device. For example, a user can dial feature code *11 at the fixed communication device to obtain the device IP address from the gateway, so that the device IP address can be displayed on the CID display at the fixed communication device. The network infrastructure devices of interest are those providing or facilitating voice communications services networks, such as edge routers, media gateways, centralized media gateways, session border controllers, trunk gateways, media boxes, call servers, and the like, and variants or evolutions thereof.

A communication protocol for phones attached to VoIP gateways can provide for enhanced communication between a phone which can only communicate with DTMF signals and a residential gateway which provides access to the Internet. A conventional residential gateway used for VoIP presents a barrier to the flow of additional and enhanced telephony information. VoIP signaling protocols such as SIP, used by IP phones and software phones, provide enhanced capabilities which are enabled for the telephone by the present disclosure. The communication protocol of the present disclosure also allows for interrogation of a gateway by a phone to determine configuration information and allows for automated notification of interruption and restoration of service.

Further in accordance with exemplary embodiments, a gateway is provided with the ability to receive a pre-defined configuration query from a fixed communication device, and to transmit a message with the requested configuration information to the fixed communication device, in a manner so that the configuration information is displayed on a display provided at the fixed communication device, which can be readily utilized with a conventional fixed communication device such as a typical home phone.

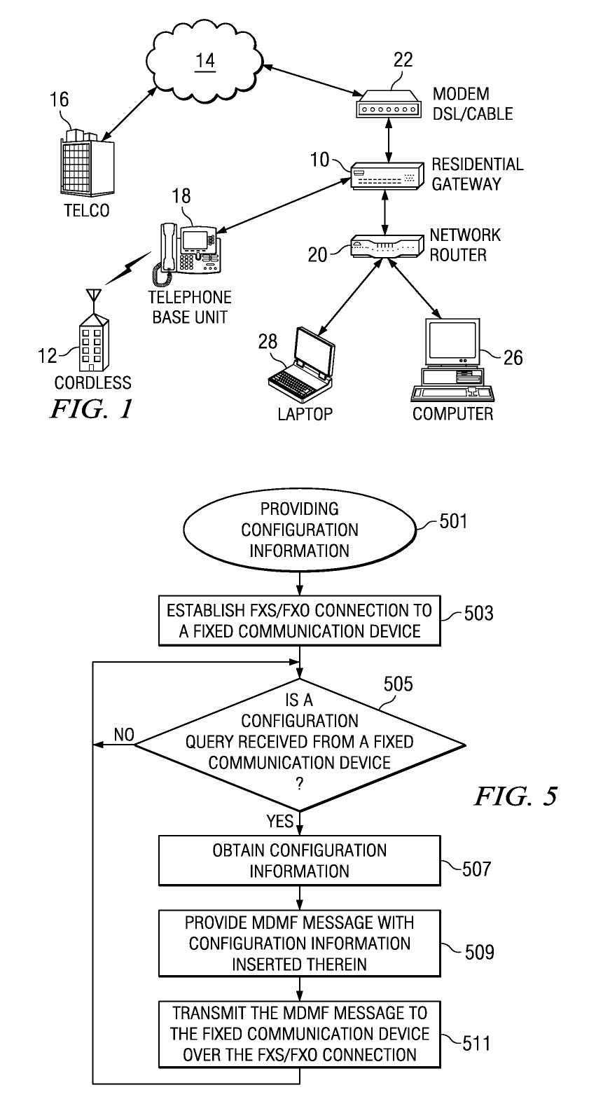

Referring now to FIG. 1, a diagram illustrating a simplified and representative environment associated with a fixed communication device and a gateway will be discussed and described. The illustration of FIG. 1 includes a typical residential gateway (RGW) interconnection. The residential gateway 10, if used for telephony, such as VoIP, will connect to a home phone 12, and connect the home phone 12 to the Internet 14, for example through a modem 22. Also shown in this illustration are a personal computer (PC) 26, laptop 28, which connected to the residential gateway 10 via a network router 20. Although a residential gateway 10 provides connectivity, when used for VoIP, a residential gateway 10 traditionally presents a barrier to the flow of additional and enhanced telephony information from the telco central office 16 to the residential phone 12. A residential gateway 10, although connected to the Internet 14 and able to communicate with other parties, does not readily pass any information through to the telephone 12, which acts like a POTS (plain old telephone service) phone and only receives limited data, such as telephone numbers.

Further, because of the limited communication of information between the conventional gateway and a telephone system, a conventional VoIP gateway does not provide access to a user to find the IP address of the device or other device configuration information which may be essential for troubleshooting or for communicating with device. For devices that provide telephony service, there have been some solutions such as announcing the device configuration to the user when user goes off-hook or devices such as printers/fax machines which can print the device configuration page. The use of voice announcements can be annoying when not needed and take significant flash space. Use of printers or fax machines requires additional equipment, added complexity, inconvenience and expense.

The user can dial predefined feature codes and the device configuration information will be displayed on the OD (onboard display). For example, the device IP address of the RGW 10 can be displayed when the user dials feature code *11. Additional codes, translated as described herein can retrieve and/or reset other device configurations.

The gateway 10 can be provided with specially programmed software and/or hardware to provide configuration information to a fixed communication device. Accordingly, there can be provided a computer-readable medium comprising instructions being executed by a computer, for example a computer incorporated in the gateway 10. The instructions can be directed to a computer-implemented method for providing configuration information from a gateway to a fixed communication device. The instructions can provide for establishing an FXS/FXO connection from a gateway to a fixed communication device; detecting a configuration query received from the fixed communication device over the FXS/FXO connection, the configuration query indicating a network infrastructure device for which configuration information is requested; obtaining configuration information corresponding to the network infrastructure device; providing a message with the configuration information inserted therein; and transmitting the message to the fixed communication device over the FXS/FXO connection.

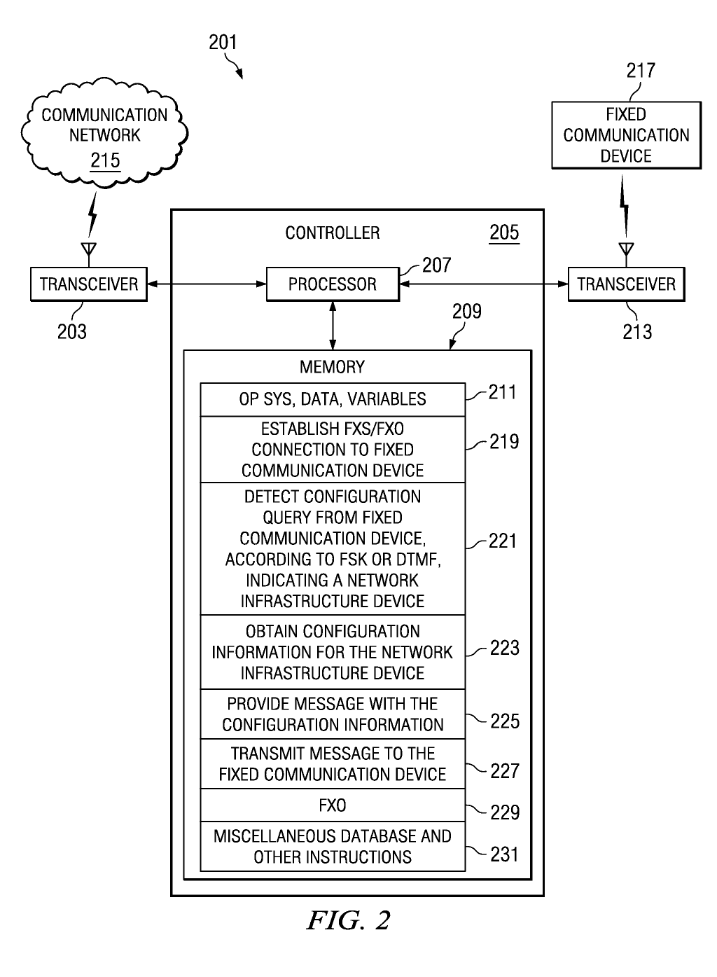

Referring now to FIG. 2, a diagram illustrating portions of a gateway will be discussed and described. The gateway 201 is assigned, in the usual manner, a unique logical address value for the communication network 215, for example an IP address value. The gateway 201 may include a first transceiver 203 for communicating over the communication network 215, a second transceiver 213 for communicating with a fixed communication device 217, and one or more controllers 205. The first transceiver 203 is representative of a combination of any number of transmitters and/or receivers, and may have a wireless or wired connection to the communication network 215. Also, the second transceiver 213 can be representative of a combination of transmitters and/or receivers and may have a wireless or wired connection to the fixed communication device 217.

The controller 205 may include a processor 207, a memory 209, and other optional components which will be well understood to those in this field. A display, a keyboard, and/or other display and input device for interacting with the user, such as a track ball, console, keypad, and/or similar optionally can be provided with the gateway 201.

The processor 207 may be, for example, one or more microprocessors and/or one or more digital signal processors. The memory 209 may be coupled to the processor 207 and may comprise a read-only memory (ROM), a random-access memory (RAM), a read/write flash memory, a programmable ROM (PROM), and/or an electrically erasable read-only memory (EEPROM). The memory 209 may include multiple memory locations for storing, among other things, an operating system, data and variables 211 for programs executed by the processor 207; computer programs for causing the processor to operate in connection with various functions such as establishing 219 an FXS/FXO connection to a fixed communication device; detecting 221 a configuration query from the fixed communication device, according to FSK or DTMF, the query indicating a network infrastructure device; obtaining 223 configuration information for the network infrastructure device; providing 225 a message with the configuration information; and transmitting 227 the message to the fixed communication device; and a database 231 of various information and other instructions used by the processor 207. The computer programs may be stored, for example, in ROM or PROM and may direct the processor 207 in controlling the operation of the gateway 201. Each of these computer programs is discussed by way of example below.

The processor 207 may be programmed for establishing 219 an FXS/FXO connection to a fixed communication device 217. For example, the fixed communication device 217 can go off-hook, or DTMF tones can be received at the second transceiver 213. Conventional techniques can be used for establishing the FXS/FXO connection to the fixed communication device 217. Although this is discussed as a computer program, some or all of this functionality can be best supported in circuits.

Further, the processor 207 may be programmed for detecting 221 a configuration query from the fixed communication device, according to FSK or DTMF, the query indicating a network infrastructure device. The configuration query can be a predetermined vertical service code, more particularly a predetermined combination of humphries and numerics, or more particularly a predetermined star code (combination of humphries and/or numerics beginning with a “*”). The predetermined vertical service code can correspond to a desired network infrastructure device and/or desired configuration information (such as Internet protocol address or status). The configuration query can be received at the second transceiver 213 as FSK modulation or as DTMF tones.

Accordingly, the processor can be configured for detecting the configuration query in accordance with FSK modulation. Furthermore, the processor can be configured for detecting the configuration query in accordance with DTMF. Further, the configuration query can be a predefined sequence of DTMF tones corresponding to a vertical service code.

Although other predetermined configuration queries can be used, the following are representative examples of predetermined configuration queries:

*11=IP address (of the gateway)

*12=DNS (domain name server) address

*13=proxy address

*14=registrar address

The processor 207 may be programmed for obtaining 223 the requested configuration information for the network infrastructure device. For example, the gateway 201 can be provided with various information regarding its configuration which it can store locally. After a conventional configuration is performed on a gateway, for example, the gateway knows its IP address, DNS address, proxy address, and registrar address. Configuration information corresponding to the predetermined configuration query which is stored locally at the gateway 201 can be retrieved from local storage. Moreover, the gateway 201 can be provided with conventional techniques for querying the communication network 215 to obtain information about network infrastructure devices, such as IP address or status. The status which is requested can be status of internet connection, VoIP status, status of the network infrastructure device, and the like.

Also, the processor 207 may be programmed for providing 225 a message with the configuration information. The processor 207 can prepare a message which includes the configuration information, and which has a message format which can be received by the fixed communication device 217 and further which the fixed communication device 217 will display at its CID display. More particularly, the message with the configuration information can be in standard MDMF format. Further, the configuration information which was obtained can be inserted in a caller identifier field in the message.

The processor 207 further may be programmed for transmitting 227 the message which includes the configuration information to the fixed communication device 217 over the second transceiver 213. The message is transmitted in accordance with known procedures for transmitting a message to the fixed communication device 217 utilizing FXS/FXO techniques.

The configuration information for the network infrastructure device conveniently can be stored in the message as alpha-numeric data. When the MDMF message is a caller identifier type message, the fixed communication device 217 conventionally displays the contents of the caller identifier field on the CID display. Therefore, when the MDMF message is sent with the configuration information as discussed above, the CID display displays the requested configuration information.

Moreover, a computer-readable medium may include instructions for execution by a computer, the instructions including a computer-implemented method for providing configuration information from a gateway to a fixed communication device.

The processor 207 can be provided with additional functions, such as an FXO interface 229. The FXO interface can manage a conventional FXS/FXO connection to the fixed communication device 217 in accordance with known techniques.

Also illustrated is the database 231 of various information used by the processor 207. The database 231 is provided for local storage of information. For example, the database 231 can be used for storing some or all of the network infrastructure device configuration information specific to the gateway 201. Also, the database 231 can store network infrastructure device configuration information which was previously obtained, for example IP addresses for the gateway, the DNS, the proxy, and/or the registration, optionally with their respective last known statuses.

Accordingly, there is provided a gateway, wherein the gateway includes a transceiver operable to transmit and receive communications to a fixed communication device; and a processor cooperatively operable with the transceiver. The processor is configured to facilitate establishing an FXS/FXO connection to the fixed communication device; detecting a configuration query received via the transceiver from the fixed communication device, the configuration query indicating a network infrastructure device for which configuration information is requested; obtaining configuration information corresponding to the network infrastructure device; providing a message with the configuration information inserted therein; and transmitting the message to the fixed communication device via the transceiver.

It should be understood that various embodiments are described herein in connection with logical groupings of functions. One or more embodiments may omit one or more of these logical groupings. Likewise, in one or more embodiments, functions may be grouped differently, combined, or augmented.

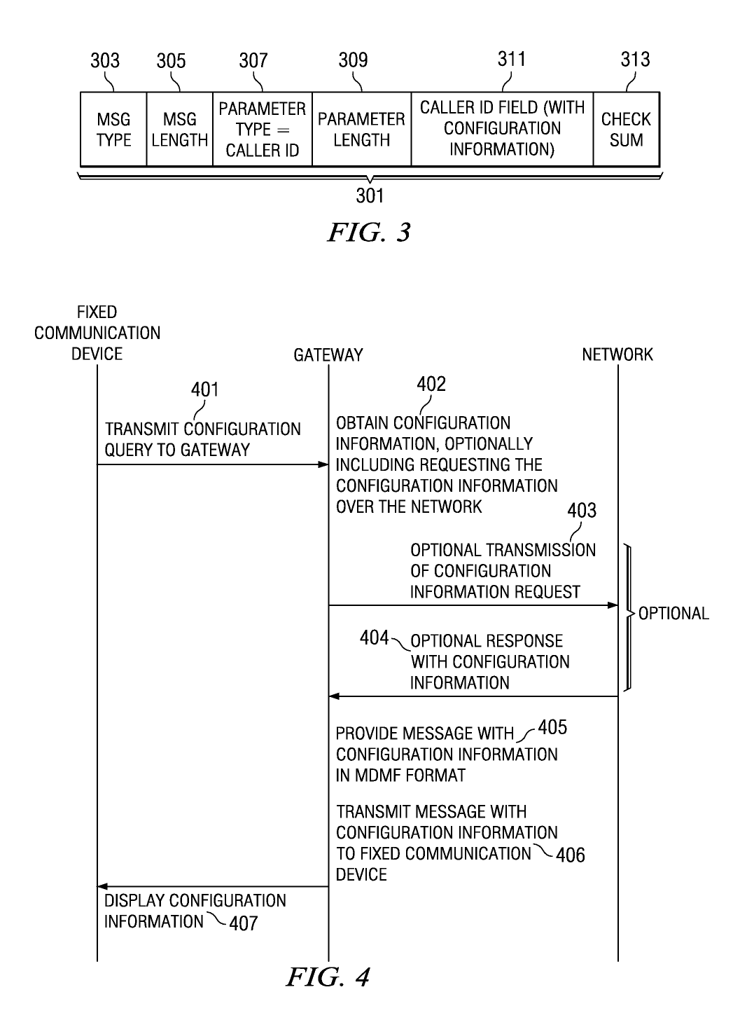

Referring now to FIG. 3, a block diagram illustrating portions of a MDMF message will be discussed and described. A message 301 in MDMF format includes a message type 303, a message length 305, a parameter type 307 (here, caller ID), a parameter length 309, a parameter data field 311 (here, the caller ID field, nevertheless containing configuration information) and a check sum 313. The parameter type 307, parameter length 309, and parameter data field 311 are commonly referred to as a presentation layer message; the message type 303, message length 305, and checksum 313 are included as part of a data link layer. The general presentation layer and data link layer formats are well understood. Typically, the message type 303 is a word with a hexadecimal value of 80, indicating an MDMF message. The message length 305 indicates the length of the data link layer message, the message length being variable. The parameter type 307 is a value which indicates “caller ID”; however, implementations may provide for a data type value which indicates “configuration information.” The parameter length 309 indicates the length of the following parameter data. The parameter field 311 contains the configuration information which was obtained for the network infrastructure device. The check sum 313 can be a conventional check sum.

Accordingly, the message with the configuration information which is transmitted to the fixed communication device is a multiple data message format (MDMF) message. Furthermore, the message into which the configuration information is inserted can be a caller identifier (CID) message, wherein the processor further inserts the configuration information in a caller identifier field in the message.

If the configuration information is not obtained in displayable text, then it is converted into displayable text and stored. For example, the configuration information that is placed into the data field 309 can be stored as ASCII text, because the caller ID field is conventionally expected to have ASCII text which is ready for display by the fixed communication device. Thus, if the data obtained is provided as numerical data (such as IP address), it can be translated and stored in the data field 309 as the ASCII representation of the numerical data.

Optionally, the MDMF message format can include data fields for storing both caller ID phone number and name, respectively. The principles discussed above can be extended to utilize either or both fields for displaying configuration information. For example, the caller ID phone number field and name field can be used to display the IP address and status, respectively, of the network infrastructure device.

Referring now to FIG. 4, a packet flow diagram illustrating a flow of transmissions for providing configuration information from a gateway to a fixed communication device will be discussed and described. A fixed communication device transmits 401 a configuration query to a gateway. The gateway obtains 402 the configuration information; as described above, the process of obtaining the configuration information can include obtaining the configuration information from the network itself. Optionally, the gateway transmits 403 a configuration information request over the network; the network transmits 404 a response (received by the gateway) which includes the requested configuration information.

Then, the gateway provides 405 a message with the configuration information, the message being in MDMF format. For example, the gateway can prepare an MDMF format message and can insert the configuration information, data length, data type, and check sum into the MDMF format message. The gateway then transmits 406 the message in MDMF format with the configuration information to the fixed communication device. Upon receipt of the MDMF format message with the caller ID data type, the fixed communication device displays the contents of the caller ID field (that is, the configuration information) on the caller ID display. Consequently, the caller ID display displays the configuration information which was requested, that is, an IP address and/or a status of a particular network infrastructure device.

Accordingly, the configuration information can be an Internet protocol (IP) address or a status of the network infrastructure device.

The flow of transmissions for providing configuration information from a gateway to a fixed communication device can occur anytime when the fixed communication device is off hook. For example, the transmission (401) of the configuration query to the gateway can be the first message to the gateway after the fixed communication device goes off hook, and/or the transmission (401) can occur during an existing call which is established via the FXS/FXO connection to another party on the communication network.

Referring now to FIG. 5, a flow chart illustrating an exemplary procedure for providing configuration information will be discussed and described. The procedure can advantageously be implemented on, for example, a processor of a gateway, described in connection with FIG. 2 or other apparatus appropriately arranged.

In overview, a procedure for providing 501 configuration information can include establishing 503 an FXS/FXO connection to a fixed communication device, and checking 505 whether a configuration query is received from a fixed communication device. The procedure 501 includes, if there is a configuration query, obtaining 507 configuration information, providing 509 an MDMF message with the configuration information inserted therein, and transmitting 511 the MDMF message to the fixed communication device over the FXS/FXO connection. Each of these is discussed in more detail below, except that details which were discussed above will not be repeated below.

The procedure 501 includes establishing 503 an FXS/FXO connection to a fixed communication device. The FXS/FXO connection to the fixed communication device can be established in accordance with conventional techniques.

The procedure 501 includes checking 505 whether a configuration query is received from a fixed communication device. That is, at some time during the FXS/FXO connection, the configuration query (as discussed above) can be received. The checking 505 for the configuration query can continue to be made while the FXS/FXO connection is established.

The procedure 501 includes, if there is a configuration query, obtaining 507 the requested configuration information. For example, first the type of information which is requested can be determined, and next the information can be obtained. This can conveniently be implemented by a configuration information table which is addressable by the particular type of configuration query and which stores the configuration information and/or which includes rules for obtaining the configuration information.

An example configuration information table is provided below for obtaining IP addresses, with the information having been previously stored, as discussed above:

| | |
|---|---|
| *11 | IP address (of the gateway) value |
| *12 | DNS (domain name server) address value |
| *13 | proxy address value |
| *14 | registrar address value |

The address values stored in the configuration information table conveniently can be stored in displayable characters, that is, in ASCII text.

The procedure 501 includes providing 509 an MDMF message with the configuration information inserted therein. As described above in more detail, an MDMF message in the form of a caller ID MDMF message can be created which includes the configuration information which was obtained in place of the caller ID information.

The procedure 501 includes transmitting 511 the MDMF message to the fixed communication device over the FXS/FXO connection. The MDMF message with the configuration information therein is transmitted to the fixed communication device in accordance with known techniques, for example using FSK modulation.

Because the MDMF message appears to be a caller ID MDMF message, the fixed communication device displays the contents of the MDMF message just as it would any caller ID information. Consequently, the techniques discussed herein can be used without requiring upgrades to existing fixed communication devices.

Accordingly, there is provided a computer-implemented method for providing configuration information from a gateway to a fixed communication device. The method can include establishing an FXS/FXO connection from a gateway to a fixed communication device; detecting a configuration query received at the gateway from the fixed communication device over the FXS/FXO connection, the configuration query indicating a network infrastructure device for which configuration information is requested; obtaining, at the gateway, configuration information corresponding to the network infrastructure device; providing a message with the configuration information inserted therein; and transmitting the message with the configuration information from the gateway to the fixed communication device over the FXS/FXO connection.

The term “FSK” as used herein is intended to indicate various Frequency Shift Keying (FSK) standards used in various countries across the globe, including the ETSI FSK (European Telecommunications -1 and -2, ES 200 778-1 and -2, ETS 300 778-1 and -2), Bellcore FSK, BT (British Telecom) FSK and CCA (Cable Communication Association) FSK, and variations and evolutions thereof.

The term “MDMF” is used herein to indicate multiple data message format standards, for example, the presentation message format as described in the European Telecommunications Standard ETS 300 659-1, and variations and evolutions thereof, which is for example used in connection with fixed communication device line protocol.

The term “fixed communication device” as used herein specifically means a telephone handset device that operates in accordance with FXS/FXO procedures, sometimes referred to as a two-wire telephone, a residential phone, analog phone, or a local phone, where the handset can be connected by a telephone line cord or wirelessly, directly or indirectly (such as via a base station) as an FXO device to the gateway operating as an FXS device, in accordance with known FXS/FXO connection techniques. Such a device can generate DTMF. The term “fixed communication device” as used herein does not encompass cellular communication device capability, such as where the cellular communication device is associated with a subscriber on a cellular communication network.

The term “gateway” is used above in the detailed description and in the claims to specifically mean any of various network devices providing or communicating on VOP networks, that is, a hardware device connecting an internal network with a wide area network (WAN) or the Internet. The gateway can provide network address translation so as to allow the computers in the internal network to share one IP address and Internet connection and Internet connection, and can combine the functions of an IP router, multi-port Ethernet switch and/or wireless access point; the gateway may be located between the modem and the internal network, or a DSL or cable modem may be integrated into the gateway. The gateway can incorporate various proprietary devices and/or devices which are the subject of standardization efforts such as the Home Gateway Initiative (HGI), and the like, and variants or evolutions thereof. Such devices are sometimes colloquially referred to as “residential gateways,” “home gateways,” “home routers,” or “broadband routers.” The designation “VoIP gateway” is used herein to indicate such a gateway specifically including functionality to communicate using VoIP.

It should be noted that the term “network infrastructure device” denotes a device or software that receives communications via a communication network (as described below), determines a next network point to which the communications should be forwarded toward their destinations, and then forwards the communications. Typically the network infrastructure device is assigned a unique Internet protocol (IP) address. Examples of network infrastructure devices include devices and/or software which are sometimes referred to as routers, edge routers, switches, bridges, brouters, gateways, home gateways, media gateways, centralized media gateways, session border controllers, trunk gateways, call servers, hubs, and the like, and variants or evolutions thereof.

Furthermore, the communication networks of interest include those that transmit information in packets, for example, those known as packet switching networks, more particularly using VOP (voice over packet) protocol, and even more particularly using VoIP (voice over IP) protocol, and even more particularly using SIP-formatted packets. Such networks can include, by way of example, the Internet, intranets, local area networks (LAN), wireless LANs (WLAN), wide area networks (WAN), and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A gateway, comprising:
a transceiver operable to transmit and receive communications to a fixed communication device; and
a processor cooperatively operable with the transceiver, the processor being configured to facilitate
establishing an FXS/FXO connection to the fixed communication device;
detecting a configuration query received via the transceiver from the fixed communication device, the configuration query indicating a network infrastructure device for which configuration information is requested;
obtaining configuration information corresponding to the network infrastructure device;
providing a message with the configuration information inserted therein; and
transmitting the message to the fixed communication device via the transceiver.

2. The gateway of claim 1, wherein the message with the configuration information which is transmitted to the fixed communication device is a multiple data message format (MDMF) message.

3. The gateway of claim 1, wherein the message into which the configuration information is inserted is a caller identifier (CID) message, wherein the processor further inserts the configuration information in a caller identifier field in the message.

4. The gateway of claim 1, wherein the configuration information is an Internet protocol (IP) address or a status of the network infrastructure device.

5. The gateway of claim 1, wherein the processor is further configured for detecting the configuration query in accordance with FSK modulation.

6. The gateway of claim 1, wherein the processor is further configured for detecting the configuration query in accordance with DTMF.

7. The gateway of claim 1, wherein the configuration query is a predefined sequence of DTMF tones corresponding to a vertical service code.

8. A computer-readable medium comprising instructions being executed by a computer, the instructions including a computer-implemented method for providing configuration information from a gateway to a fixed communication device, the instructions for implementing:
establishing an FXS/FXO connection from a gateway to a fixed communication device;
detecting a configuration query received from the fixed communication device over the FXS/FXO connection, the configuration query indicating a network infrastructure device for which configuration information is requested;
obtaining configuration information corresponding to the network infrastructure device;
providing a message with the configuration information inserted therein; and
transmitting the message to the fixed communication device over the FXS/FXO connection.

9. The computer-readable medium of claim 8, wherein the message with the configuration information which is transmitted to the fixed communication device is a multiple data message format (MDMF) message.

10. The computer-readable medium of claim 8, wherein the message into which the configuration information is inserted is a caller identifier (CID) message, further comprising inserting the configuration information in a caller identifier field in the message.

11. The computer-readable medium of claim 8, wherein the configuration information is an Internet protocol (IP) address or a status of the network infrastructure device.

12. The computer-readable medium of claim 8, wherein the processor is further configured for detecting the configuration query in accordance with FSK modulation.

13. The computer-readable medium of claim 8, wherein the processor is further configured for detecting the configuration query in accordance with DTMF.

14. The computer-readable medium of claim 8, wherein the configuration query is a predefined sequence of DTMF tones corresponding to a vertical service code.

15. A computer-implemented method for providing configuration information from a gateway to a fixed communication device, comprising:
establishing an FXS/FXO connection from a gateway to a fixed communication device;
detecting a configuration query received at the gateway from the fixed communication device over the FXS/FXO connection, the configuration query indicating a network infrastructure device for which configuration information is requested;
obtaining, at the gateway, configuration information corresponding to the network infrastructure device;
providing a message with the configuration information inserted therein; and
transmitting the message with the configuration information from the gateway to the fixed communication device over the FXS/FXO connection.

16. The method of claim 15, wherein the message with the configuration information which is transmitted to the fixed communication device is a multiple data message format (MDMF) message.

17. The method of claim 15, wherein the message into which the configuration information is inserted is a caller identifier (CID) message, further comprising inserting the configuration information in a caller identifier field in the message.

18. The method of claim 15, wherein the configuration information is an Internet protocol (IP) address or a status of the network infrastructure device.

19. The method of claim 15, wherein the processor is further configured for detecting the configuration query in accordance with FSK modulation.

20. The method of claim 15, wherein the processor is further configured for detecting the configuration query in accordance with DTMF.
